(19) United States
(12) Patent Application Publication
(10) Pub. No.: US 2024/0200755 A1
(43) Pub. Date: Jun. 20, 2024

(54) THIN FILM FILTER REEL FOR OPTICAL SYSTEMS

(71) Applicant: BAE Systems Information and Electronic Systems Integration Inc., Nashua, NH (US)

(72) Inventors: Matthew F. Kepler, Austin, TX (US); Chris B. O'Brien, Paige, TX (US)

(73) Assignee: BAE Systems Information and Electronic Systems Integration Inc., Nashua, NH (US)

(21) Appl. No.: 18/065,976

(22) Filed: Dec. 14, 2022

(51) Int. Cl. F21V 14/00; F21V 9/40; F21V 14/08; G02B 5/20

(52) U.S. Cl. CPC F21V 14/006; F21V 9/40; F21V 14/08; G02B 5/20

(57) ABSTRACT

A filter assembly of an optical system. The filter assembly may include a first spool, a second spool, and a film filter that operably engages with the first spool and the second spool and the film filter having at least two filters that are different from one another. The filter assembly may also include a drive assembly that operably engages with one of the first spool, the second spool, and the film filter for moving at least one filter of the at least two filters into optical alignment with a focal plane sensor of the optical system. The film filter of the filter assembly may also be made from a flexible material that bends when wound about the first spool and the second spool.

### TECHNICAL FIELD

The present disclosure generally relates to optical systems with various optical filters for modifying optical characteristics of light.

### BACKGROUND

Optical systems used in military operations generally include a camera or sensor along with at least one filter or filter assembly. These filters or filter assemblies are generally used for modifying optical characteristics of incoming signals or light emitted from a targeted remote object in the far field of view. As used herein, light refers to the broad range of electromagnetic radiation including visible light and infrared. Generally, these filters may be spectral-based where each filter may be configured to allow and/or transmit a specific color or wavelength of the received light to a camera or sensor in the optical systems. In one instance, these filters may be notch filters where each filter may block out a specific color or wavelength of light to a camera or sensor in the optical systems. In another instance, these filters may be neutral density filters where each filter may block a certain percentage of the light without performing spectral modification prior to being received by a camera or sensor in the optical systems. Generally, however, conventional optical systems may include or need multiple filters to allow or transmit specific colors or wavelengths of light to a camera or sensor in these conventional optical system during military operations.

To implement the need for various optical filters, conventional optical systems implement a mechanical support structure to house these individual filters. In one instance, conventional optical systems may implement a filter wheel that places individual filters radially about the wheel so that a specific filter may be aligned in front of the camera or sensor. However, these conventional mechanical support structures, such as filter wheels, are rather bulky and require large amounts of volume inside of the optical system. Additionally, these filter wheels define a finite amount of capacity in which these filter wheels are only able to hold or support a limited quantity of filters. Moreover, conventional filters used in these filter wheels typically have large thicknesses, which, when combined with the filter wheel holding these filters, creates even thicker assemblies making it extremely difficult to fit these assemblies between lens and cameras or sensors and can, in some instances, require the addition of an afocal region or focus adjustments to accommodate the bulk filters. Furthermore, conventional support structures, like filter wheels, include dead or unused spaces between each filter in order to adequately support each filter inside of the filter wheel thus limiting the number of filters that can be provided in filter wheels.

### SUMMARY

In one aspect, an exemplary embodiment of the present disclosure may provide a filter assembly of an optical system. The filter assembly may include a first spool, a second spool, and a film filter that operably engages with the first spool and the second spool and the film filter having at least two filters that are different from one another. The filter assembly may also include a drive assembly that operably engages with one of the first spool, the second spool, and the film filter for moving at least one filter of the at least two filters into optical alignment with a focal plane sensor of the optical system.

This exemplary embodiment or another exemplary embodiment may further include that the film filter is a flexible material that bends when wound about the first spool and the second spool. This exemplary embodiment or another exemplary embodiment may further include that the film filter further comprises: a first filter of the at least two filters defining a first filter modification for transmitting a first color of light to the focal plane sensor; and a second filter of the at least two filters defining a second filter modification for transmitting a second color of light to the focal plane sensor; wherein the first filter configuration and the second configuration are different from one another. This exemplary embodiment or another exemplary embodiment may further include that the film filter further comprises: at least one non-uniform correction (NUC) shutter positioned adjacent to one of the at least two filters; wherein the at least one NUC shutter is nontransparent and substantially prevents light from being transmitted to the focal plane sensor. This exemplary embodiment or another exemplary embodiment may further include at least one biaser operably engaged inside of one of the first spool and the second spool for providing tension along the film filter. This exemplary embodiment or another exemplary embodiment may further include that a motor of the drive assembly; and a drive shaft operably engaged with the motor and one of the first spool and the second spool. This exemplary embodiment or another exemplary embodiment may further include at least one encoder operably engaged with the drive shaft; wherein the at least one encoder is adapted to monitor the drive shaft to determine when each filter of the at least two filters is aligned in front of the focal plane sensor. This exemplary embodiment or another exemplary embodiment may further include that when the drive shaft rotates to a first rotational position, the at least one encoder determines that a first filter of the at least two filters is aligned in front of the focal plane sensor; and when the drive shaft rotates to a second rotational position different than the first rotational position, the at least one encoder determines that a second filter of the at least two filters is aligned with the focal plane sensor. This exemplary embodiment or another exemplary embodiment may further include that the motor is a stepper-type motor adapted to monitor the rotation of the drive shaft to determine when each filter of the at least two filters is optically aligned with the focal plane sensor of the optical system. This exemplary embodiment or another exemplary embodiment may further include that when the drive shaft rotates to a first rotational position, the motor determines that a first filter of the at least two filters is aligned with the focal plane sensor; and when the drive shaft rotates to a second rotational position different than the first rotational position, the motor determines that a second filter of the at least two filters is aligned with the focal plane sensor. This exemplary embodiment or another exemplary embodiment may further include at least one optical encoder operably engaged with one of the film filter and the drive shaft of the drive assembly; wherein the at least one optical encoder is adapted to monitor one of the film filter and the drive shaft to determine when each filter of the at least two filters is optically aligned with the focal plane sensor. This exemplary embodiment or another exemplary embodiment may further include that the film filter further comprises: a first end operably engaged with the first spool; a second end opposite to the first end and operably engaged with the second spool; and at least one set of apertures defined in the film filter and extending between the first end and the second end. This exemplary embodiment or another exemplary embodiment may further include that the drive assembly comprises: a motor of the drive assembly; a drive shaft operably engaged with the motor; and at least one sprocket operably engaged with the film filter via the at least one set of apertures. This exemplary embodiment or another exemplary embodiment may further include at least one roller mechanism operably engaged with the film filter and positioned intermediately the first spool and the second spool; wherein the drive assembly is operably engaged with the at least one roller mechanism for advancing the at least one filter of the at least two filters in front of the focal plane sensor of the optical system. This exemplary embodiment or another exemplary embodiment may further include that the film filter is one of positioned between the focal plane sensor of the optical system and a lens assembly of the optical system, positioned ahead of the focal plane sensor and at a lens stop of the lens assembly, and positioned ahead of the focal plane sensor and the lens assembly.

In another aspect, an exemplary embodiment of the present disclosure may provide a method. The method may include steps of: receiving a light into an optical system; advancing a film filter of a filter assembly in at least one linear direction by a drive assembly of the filter assembly until a filter of at least two filters of the film filter is optically aligned with a focal plane sensor; winding the film filter about one of a first spool of the filter assembly and a second spool of the filter assembly; determining the least one filter is optically aligned with the focal plane sensor; and transmitting at least one wavelength of the light, via the filter of the at least two filters, to the focal plane sensor.

This exemplary embodiment or another exemplary embodiment may further include steps of advancing the film filter of the filter assembly in a second linear direction until at least another filter of the at least two filters of the film filter is optically aligned with the focal plane sensor; determining the at least another filter is optically aligned with the focal plane sensor by an encoder of the filter assembly; and transmitting at least another wavelength of the light, via the at least one filter, to the focal plane sensor; wherein the at least another wavelength of the light is different than the at least one wavelength of the light. This exemplary embodiment or another exemplary embodiment may further include steps of advancing the film filter of the filter assembly in a third linear direction until a non-uniform correction (NUC) shutter of the film filter is optically aligned with the focal plane sensor; and blocking the light, via the NUC shutter, from transmitting to the focal plane sensor. This exemplary embodiment or another exemplary embodiment may further include that the step of advancing the film filter of the filter assembly further comprises: engaging a drive shaft of a drive assembly of the filter assembly with one of the first spool and the second spool; and rotating the drive shaft, via a motor of the drive assembly, in the at least one linear direction. This exemplary embodiment or another exemplary embodiment may further include that the step of advancing the film filter of the filter assembly further comprises: engaging a sprocket of a drive assembly of the filter assembly with the film filter; and rotating a drive shaft of the drive assembly, via a motor of the drive assembly, in the at least one linear direction. This exemplary embodiment or another exemplary embodiment may further include that the step of advancing the film filter of the filter assembly further comprises: engaging at least one roller mechanism of a drive assembly with the film filter; and rotating the at least roller mechanism, via a motor of the drive assembly, in the at least one linear direction.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view of optical system, wherein the optical system includes a filter assembly in accordance with one aspect of the present disclosure.

FIG. 2 (FIG. 2) is a partial top plan view of a film filter of the filter assembly shown in FIG. 1.

FIG. 3A (FIG. 3A) is a diagrammatic sectional view of the filter assembly shown in FIG. 1.

FIG. 3B (FIG. 3B) is a diagrammatic view of the filter assembly shown in FIG. 1, wherein a drive assembly of the filter assembly is operably engaged with at least one spool of the filter assembly and includes an encoder.

FIG. 4 (FIG. 4) is diagrammatic view of an alternative filter assembly in accordance with another aspect of the present disclosure, wherein a drive assembly of the filter assembly is operably engaged with a film filter of the filter assembly.

FIG. 5 (FIG. 5) is diagrammatic view of an alternative filter assembly in accordance with another aspect of the present disclosure, wherein a drive assembly of the filter assembly is operably engaged a film filter of a filter assembly and includes a stepper-type motor.

FIG. 6 (FIG. 6) is a diagrammatic view of an alternative filter assembly in accordance with another aspect of the present disclosure that includes an optical encoder.

FIG. 7 (FIG. 7) is a diagrammatic view of an alternative filter assembly in accordance with another aspect of the present disclosure, wherein a drive assembly of the filter assembly includes a set of roller mechanisms.

FIG. 8 (FIG. 8) is an exemplary method flowchart.

Similar numbers refer to similar parts throughout the drawings.

### DETAILED DESCRIPTION

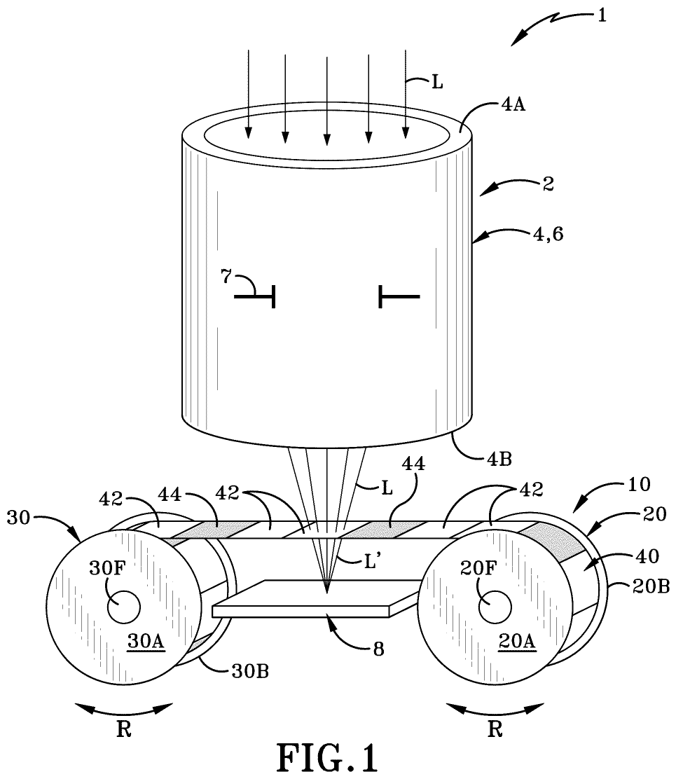

FIGS. 1, 6, and 7 illustrate an optical system, generally referred to as 1, that may be provided on any available platforms, which are described in more detail below. It should be appreciated that optical system 1 may include any cameras and/or sensors that are commercially available at this time or any cameras and/or sensors that are not currently available at this time. It should also be appreciated that optical system 1 may be used for specific implementation, including long wave infrared (LWIR) cameras and other infrared cameras of the like.

As described previously, optical system 1 may be provided on any available platform, including stationary platforms or mobile platforms. In one instance, optical system 1 may be provided on a stationary platform, including stationary platforms for military operations or for civilian operations such as buildings, towers, or other stationary platforms of the like. In another instance, optical system 1 may be provided on a mobile platform, including mobile platforms for military operations or for civilian operations. More particularly, continuing with this instance, these mobile platforms may be platforms suitable for air travel, land travel, sea travel, space travel, and other suitable mobile platforms of the like.

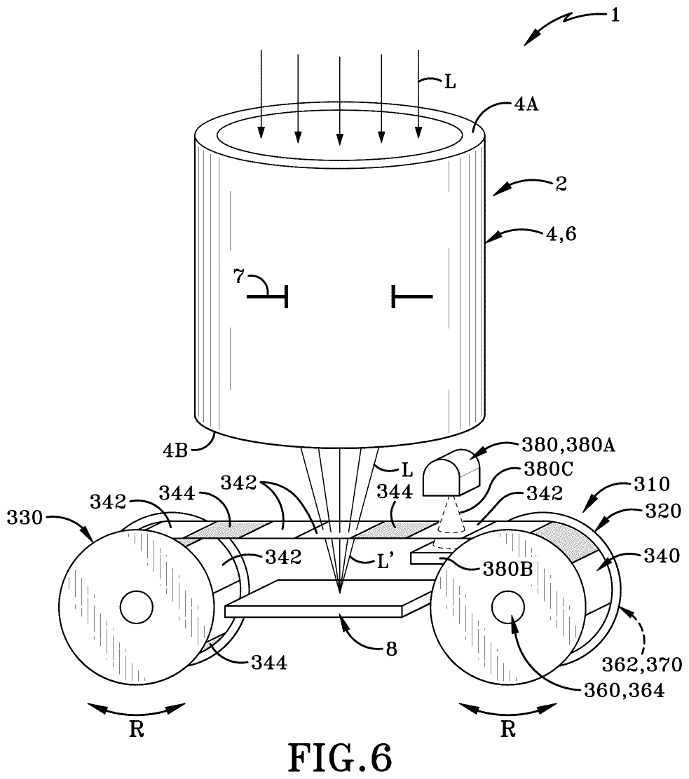

Optical system 1 may include a lens assembly 2. As best seen in FIGS. 1 and 6, lens assembly 2 includes a housing 4 having a first end 4A facing towards a far field and/or at least one object positioned remote from the optical system 1. Housing 4 may also include a second end 4B opposite to the first end 4A and facing into the optical system 1. Lens assembly 2 may also include at least one lens or optical element 6 that is positioned inside of housing 4 between the first end 4A and the second end 4B. In one instance, optical element 6 may be positioned forwardly and/or ahead of a lens pupil stop 7 provided in lens assembly 2, in other words, positioned between the first end 4A and the lens pupil stop 7. In another instance, optical element 6 may be positioned rearward of and/or behind the lens pupil stop 7 provided in lens assembly 2, in other words, positioned between the second end 4B and the lens pupil stop 7. During operation, lens assembly 2 may initially receive light “L” emitted from a remote object observed and/or targeted in the far field remote from the lens assembly 2 (see FIGS. 1, 6, and 7). While not illustrated herein, lens assembly 2 may receive light “L′” emitted from a remote object observed and/or targeted in the far field subsequent to being modified and/or altered light by a filter assembly of optical system 1; such filter assembly is described in greater detail below.

It should be appreciated that any suitable lens assembly 2 may be used in optical system 1 that is commercially available at this time or currently not available at this time. Moreover, it should be appreciated that lens assembly 2 may include any suitable number of lens or optical elements dictated by the implementation of optical system 1.

Optical system 1 may also include a focal plane sensor 8. As best seen in FIGS. 1, 6, and 7, focal plane sensor 8 is positioned rearwardly of the lens assembly 2 such that focal plane sensor 8 receives the light “L” emitted from the remote object after being directed through the lens assembly 2. More particularly, focal plane sensor 8 is positioned rearward of the housing 4 and the at least one optical element 6 such that focal plane sensor 8 receives the light emitted from a remote object after being directed through the at least one optical element 6. Generally, the focal plane sensor 8 is used to generate or produce an image based on the light emitted by the remote object in the far field. It should be appreciated that any suitable focal plane sensor 8 may be used in optical system 1 that is commercially available at this time or currently not available at this time.

Optical system 1 may also include a filter assembly 10 that is configured to modify and/or narrow optical characteristics of light “L′ entering into the optical system 1 emitted by the remote object. Stated differently, filter assembly 10 is configured to filter or allow a specific and/or desired color or wavelength of the light “L” that initially enters into the optical system 1 when a desired filter is optically aligned with the focal plane sensor 8; such filters of the filter assembly 10 are described in more detail below. Such components and element of filter assembly 10 are also described in greater detail below.

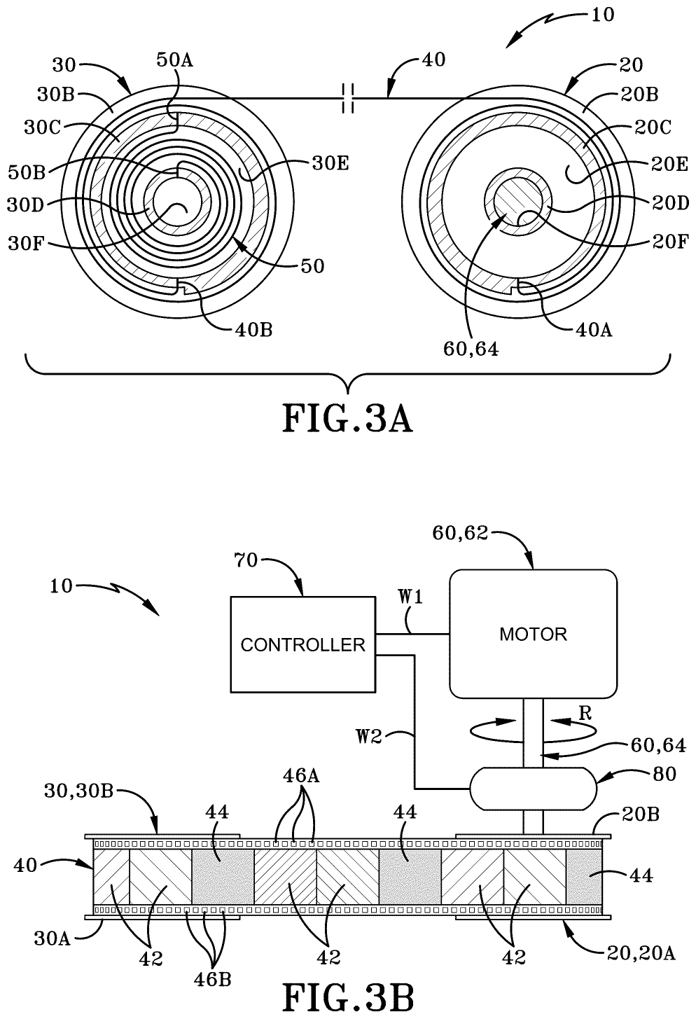

Filter assembly 10 may include a first spool or reel 20. As best seen in FIG. 1, first spool 20 includes a first upright wall 20A, a second upright wall 20B opposite to first upright wall 20A, and a first or exterior cylindrical wall 20C extending longitudinally between first upright wall 20A and second upright wall 20B (see FIG. 3A). As best seen in FIG. 1, portions of first upright wall 20A and second upright wall 20B positioned vertically above exterior cylindrical wall 20C may act as rims or barriers to keep a film filter (described in more detail below) of filter assembly 10 on first spool 20 during operation. First spool 20 may also include a second or interior cylindrical wall 20D extending longitudinally between first upright wall 20A and second upright wall 20B and interior of exterior cylindrical wall 20C (see FIG. 3A). As best seen in FIG. 3A, first spool 20 may also include an interior chamber 20E that is collectively defined by exterior cylindrical wall 20C and interior cylindrical wall 20D; such use and purpose of interior chamber 20E is described in more detail below. Referring to FIGS. 1 and 3A, first spool 20 may also include a passageway 20F that is collectively defined by first upright wall 20A, second upright wall 20B, and interior cylindrical wall 20D in which passageway 20F is accessible at either first upright wall 20A or second upright wall 20B; such use and purpose of passageway 20F is described in more detail below.

Filter assembly 10 may also include a second spool or reel 30 positioned adjacent to first spool 20 and spaced apart from first spool 20. As described herein, second spool 30 includes features and characteristics substantially similar to the features and characteristics of first spool 20 described above. As best seen in FIGS. 1 and 3A, second spool 30 include a first upright wall 30A, a second upright wall 30B, a first or exterior cylindrical wall 30C, a second or interior cylindrical wall 30D, an interior chamber 30E, and a passageway 30F substantially similar to first upright wall 20A, second upright wall 20B, exterior cylindrical wall 20C, interior cylindrical wall 20D, interior chamber 20E, and passageway 20F of first spool 20.

Filter assembly 10 may also include a film filter 40 that operably engages with first spool 20 and second spool 30 such that the spools are oriented to allow for the film filter to filter the light “L” coming from the lens assembly 2. In this example the film 40 is positioned approximately orthogonal to the light “L” and retained in place by the spools 20, 30. As best seen in FIGS. 1 and 3, film filter 40 is made from flexible material to enable to film filter 40 to be wound about one or both of first spool 20 and second spool 30. Such flexible capability of the film filter 40 enables first spool 20 and second spool 30 to house and/or maintain portions of film filter 40 for advancing desired filters and shutters ahead of the focal plane sensor 8; such filters and shutter of film filter 40 are described in more detail.

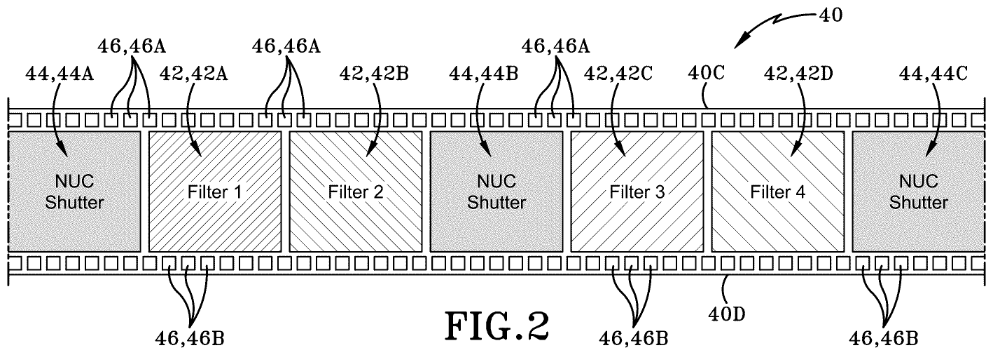

As best seen in FIG. 3A, film filter 40 includes a first end 40A, a second end 40B longitudinally opposite to the first end 40A, and a longitudinal axis defined therebetween. In the illustrated embodiment, the first end 40A of film filter 40 operably engages with first spool 20, and the second end 40B of film filter 40 operably engages with the second spool 30. More particularly, the first end 40A of film filter 40 operably engages with exterior cylindrical wall 20C of first spool 20, and the second end 40B of film filter 40 operably engages with exterior cylindrical wall 30C of the second spool 30. As best seen in FIG. 2, film filter 40 also includes an upper edge 40C that extends longitudinally between the first end 40A and the second end 40B. Still referring to FIG. 2, film filter 40 also include a lower edge 40D opposite to the upper edge 40C and extends longitudinally between the first end 40A and the second end 40B.

It should also be appreciated that film filter 40 is made of flexible material such that film filter 40 may be wound about either first spool 20 and the second spool 30. Such flexible configuration of film filter 40 enables first spool 20 and second spool 30 to hold various amounts of film filter 40 for conserving space to position other components and/or devices near and/or proximate to the filter assembly 10 as compared to conventional filter assemblies known in the art.

It should also be appreciated that film filter 40 may be manufactured from any suitable flexible material that is configured to be wound about first spool 20 and/or second spool 30. Generally, film filter 40 may be manufactured from a flexible, plastic material that is configured to be wound about first spool 20 and/or second spool 30. Examples of suitable flexible, plastic materials include polycarbonates, acrylics, nylons, polyesters, polyurethanes, polyolefins, polypropylene, cellulose acetates, triacetates, vinyl acetals, polyvinyl, polyimide, vinyl chloride polymers, and copolymers, polyetheretherketone (PEEK), polyethylene terephthalate, and other suitable flexible, plastic materials of the like.

It should also be appreciated that such use of flexible, plastic materials may also enable film filter 40 to define a substantially thin profile for enabling film filter 40 to be wound about one or both of first spool 20 and second spool 30 for conversing space inside of optical system 1. In one instance, film filter 40 may define a thickness of about 100 micrometers. In another instance, film filter 40 may define a thickness from about 10 micrometers to about 100 micrometers. In yet another instance, film filter 40 may define a thickness at about 10 micrometers.

Film filter 40 may also include a set of filters 42 that is positioned between the first end 40A and the second end 40B. As best seen in FIG. 2, set of filters 42 span longitudinally across the film filter 40 and may be spaced apart from one another. In the illustrated embodiment, set of filters 42 may include at least one filter or a first filter 42A (shown as “Filter 1” in FIG. 2) configured with a first filter modification to modify or allow a first color or first wavelength of light “L” to be directed to focal plane sensor 8 when first filter 42A is optically aligned with focal plane sensor 8. Set of filters 42 may also include at least another filter or a second filter 42B (shown as “Filter 2” in FIG. 2) configured with a second filter modification to modify or allow a second color or second wavelength of light to be directed to focal plane sensor 8 when second filter 42B is optically aligned with focal plane sensor 8. It should be appreciated that the second color or second wavelength of light directed to focal plane sensor 8 is different than the first color or first wavelength of light directed to focal plane sensor 8; as such, the first filter modification of first filter 42A and the second filter modification of second filter 42B are different from one another.

It should be appreciated that each filter of the set of filters 42 may define any suitable shape, size, and configuration based on the configuration of filter assembly 10. Each filer of the set of filters 42 may also be the same size or different sizes and, in one example, each filter of the set of filters 42 is sized so that there is some tolerance to allow for inaccuracies in the spool movement. The size of each filter in the set of filters 42 in terms of length and width is designed so that substantially all the incident light “L” is directed through a single filter 42. In one example, each filter in the set of filters 42 is roughly square and defines an area that is less than an area defined by the focal plane sensor 8 (see FIG. 1). In another example, each filter in the set of filters 42 is roughly square and defines an area that is greater than an area defined by the focal plane sensor 8; such example may be advantageous to ensure light “L” is substantially directed to focal plane sensor 8 to allow for inaccuracies in the spool movement. In yet another example, each filter in the set of filters 42 is roughly square and defines an area that is substantially equal with an area defined by the focal plane sensor 8; such example may be advantageous to ensure light “L” is substantially directed to focal plane sensor 8 to allow for inaccuracies in the spool movement.

Set of filters 42 in this illustrated embodiment may also include a third filter 42C (shown as “Filter 3” in FIG. 2) configured with a third filter modification to modify or allow a third color or third wavelength of light to be directed to focal plane sensor 8 when third filter 42C is optically aligned with focal plane sensor 8. Set of filters 42 may also include a fourth filter 42D (shown as “Filter 4” in FIG. 2) configured with a fourth filter modification to modify or allow a fourth color or fourth wavelength of light to be directed to focal plane sensor 8 when fourth filter 42D is optically aligned with focal plane sensor 8. It should be appreciated that the fourth color or fourth wavelength of light directed to focal plane sensor 8 is different than the third color or third wavelength of light directed to focal plane sensor 8; as such, the third filter modification of third filter 42C and the fourth filter modification of fourth filter 42D are different from one another. It should also be appreciated that the first color of light allowed by first filter 42A, the second color of light allowed by second filter 42B, the third color of light allowed by third filter 42C, and fourth color of light allowed by fourth filter 42D are different from one another; as such, the first filter modification of first filter 42A, the second filter modification of second filter 42B, the third filter modification of third filter 42C, and the fourth filter modification of fourth filter 42D are different from one another.

It should be appreciated that each filter of the set of filters 42 may have any suitable optical characteristics or modifications that enables each filter of the set of filters 42 to allow at least one color or wavelength to pass through each filter of the set of filters 42. In one instance, each filter of the set of filters 42 may be transparent to allow at least one color or wavelength to pass through each filter of the set of filters 42. In another instance, each filter of the set of filters 42 may be translucent to allow at least one color or wavelength to pass through each filter of the set of filters 42.

It should also be appreciated that each filter of the set of filters 42 is made of flexible material such that each filter of the set of filters 42 may be wound about either first spool 20 and the second spool 30. Such flexible configuration of the set of filters 42 enables first spool 20 and second spool 30 to hold various amounts of filters for conserving space to position other components and/or devices near and/or proximate to the filter assembly 10 as compared to conventional filter assemblies known in the art.

It should also be appreciated that each filter in the set of filters 42 may be manufactured from any suitable flexible material that is configured to be wound about first spool 20 and/or second spool 30. Generally, each filter in the set of filters 42 may be manufactured from a flexible, plastic material that is configured to be wound about first spool 20 and/or second spool 30. Examples of suitable flexible, plastic materials that are optically clear and/or transparent include polycarbonates, acrylics, nylons, polyesters, polyurethanes, polyolefins, polypropylene, cellulose acetates, triacetates, vinyl acetals, polyvinyl, polyimide, vinyl chloride polymers, and copolymers, polyetheretherketone (PEEK), polyethylene terephthalate, and other suitable flexible, plastic materials that are optically clear and/or transparent.

It should also be appreciated that at least one additive or coating may be applied to each filter in the set of filters 42 for modifying a light transmission property of each filter in the set of filters 42. As such, a specific additive or coating may be applied to specific filters in the set of filters 42 so that each filter in the set of filters 42 include different light transmission properties.

Film filter 40 may also include a set of non-uniform correction (NUC) shutters 44 (hereinafter “shutters”) that is positioned between the first end 40A and the second end 40B. As best seen in FIG. 2, set of shutters 44 span longitudinally across the film filter 40 and may be spaced apart from one another. In one instance, a first shutter 44A of the set of shutters 44 and a second shutter 44B of the set of shutters 44 may be spaced apart by at least one filter of the set of filters 42. In another instance, first shutter 44A of the set of shutters 44 and second shutter 44B of the set of shutters 44 may be spaced apart by at least two filters of the set of filters 42 (e.g., first filter 42A and second filter 42B) along with second shutter 44B of the set of shutters 44 and a third shutter 44C of the set of shutters 44 being spaced apart by at least another two filters of the set of filters 42 (e.g., third filter 42C and fourth filter 42D).

It should be appreciated that each shutter of the set of shutters 44 provided with film filter 40 is configured to prevent any light from passing through and/or being directed through the film filter 40 towards focal plane sensor 8. Stated differently, each shutter of the set of shutters 44 is a non-transparent element configured to prevent any light from passing through and/or being directed through the film filter 40 towards focal plane sensor 8. Such use of the set of shutters 44 is considered advantageous at least because any shutter of the set of shutters may be utilized to reset and/or recalibrate the focal plane sensor 8 when the focal plane sensor 8 switches from at least one filter of the set of filters 42 to at least another filter of the set of filters 42. In one instance, the first shutter 44A may be advanced in front of the focal plane sensor 8 when the first filter 42A or another filter (not illustrated herein) adjacent to the first shutter 44A is used. In another instance, the second shutter 44B may be advanced in front of the focal plane sensor 8 when the second filter 42B or the third filter 42C is used. In yet another instance, the third shutter 44C may be advanced in front of the focal plane sensor 8 when the fourth filter 42D or another filter (not illustrated herein) adjacent to the fourth shutter 44D is used.

It should also be appreciated that each shutter of the set of shutters 44 is also made of flexible, plastic material similar to each filter of the set of filters 42 such that each shutter of the set of shutters 44 may be wound about either first spool 20 and the second spool 30. Such flexible configuration of the set of shutters 44 enables first spool 20 and second spool 30 to hold various amounts of shutters for conserving space to position other components and/or devices near and/or proximate to the filter assembly 10 as compared to conventional filter assemblies known in the art. Moreover, providing the set of shutters 44 on the film filter 40 is considered advantageous at least because a separate shutter device or shutter system may also be removed from the optical system 1 as compared to conventionally optical systems using said separate shutter device having at least a motor or solenoid for opening and closing a mechanical shutter. Such removal of a separate shutter device or shutter system frees up space inside of optical system 1, reduces the overall weight of the optical system 1, and eliminates potential mechanical issues spawning from a separate shutter device.

It should be appreciated that each shutter in the set of shutters 44 may be manufactured from any suitable flexible material that is configured to be wound about first spool 20 and/or second spool 30. Generally, each shutter in the set of shutters 44 may be manufactured from a flexible, plastic material that is configured to be wound about first spool 20 and/or second spool 30. Examples of suitable flexible, plastic materials include polycarbonates, acrylics, nylons, polyesters, polyurethanes, polyolefins, polypropylene, cellulose acetates, triacetates, vinyl acetals, polyvinyl, polyimide, vinyl chloride polymers, and copolymers, polyetheretherketone (PEEK), polyethylene terephthalate, and other suitable flexible, plastic materials.

Film filter 40 may also define at least one set of apertures 46 that extends entirely along a periphery or edge of the film filter 40. As best seen in FIG. 2, the at least one set of apertures 46 may extend along the entire length of the film filter 40. While not illustrated herein, a set of apertures may only extend along portions of the film filter 40 at desired positions on the film filter 40 where one portion of film filter 40 is continuous and uninterrupted. In the illustrated embodiment, film filter 40 may define a first set of apertures 46A extending along the length of the film filter 40 and being positioned between the upper edge 40C of the film filter 40, the set of filters 42, and the set of shutters 44. Film filter may also define a second set of apertures 46B extending along the length of the film filter 40 and being positioned between the lower edge 40D of the film filter 40, the set of filters 42, and the set of shutters 44. Second set of apertures 46B is also defined opposite to first set of apertures 46A and spaced apart from one another such that the set of filters 42 and the set of shutters 44 separate the first set of apertures 46A and second set of apertures 46B. Such use and purpose of first set of apertures 46A and second set of apertures 46B is described in more detail below.

It should be appreciated that filter assembly 10 may be positioned at any suitable location relative to lens assembly 2 and focal plane sensor 8. In one example, filter assembly 10 may be positioned between the lens assembly 2 and the focal plane sensor 8 (see FIGS. 1, 6, and 7); more particularly, filter assembly 10 is rearward of or behind lens assembly 2 and forwardly of or ahead of focal plane sensor 8. Continuing with this example, filter assembly 10 is configured to receive the light after the lens assembly 2 and to modify and/or allow a specific color or wavelength of the light to the focal plane sensor 8. In another example, filter assembly 10 may be positioned in front of the lens assembly 2 and the focal plane sensor 8; more particularly, filter assembly 10 is forward or ahead of both lens assembly 2 and focal plane sensor 8. Continuing with this example, filter assembly 10 is configured to receive the light before the lens assembly 2 and the focal plane sensor 8 in which filter assembly 10 modifies and/or allows a specific color or wavelength of the light to the lens assembly 2 and the focal plane sensor 8. In yet another example, filter assembly 10 may be positioned at the lens pupil stop 7 of lens assembly 2; more particularly, filter assembly 10 is positioned rearward of or behind the optical element 6 at the lens pupil stop 7 and forwardly of or ahead of focal plane sensor 8. Continuing with this example, filter assembly 10 is configured to receive the light after traveling through optical element 6 and then modifies and/or allows a specific color or wavelength of the light to the focal plane sensor 8. In yet another example, filter assembly 10 may be positioned at the lens pupil stop 7 of lens assembly 2; more particularly, filter assembly 10 is positioned forwardly or ahead of the optical element 6 at the lens pupil stop 7 and forwardly of or ahead of focal plane sensor 8. Continuing with this example, filter assembly 10 is configured to receive the light before the optical element 6 and the focal plane sensor 8 in which filter assembly 10 modifies and/or allows a specific color or wavelength of the light to the optical element 6 and the focal plane sensor 8.

Filter assembly 10 may also include at least one biaser 50 that operably engages with one of the first spool 20 and the second spool 30. As best seen in FIG. 3A, a single biaser 50 operably engages with the second spool 30 inside of the interior chamber 20E. More particularly, a first end 50A of biaser 50 may operably engage with the exterior cylindrical wall 30C inside of the interior chamber 30E, and a second end 50B of biaser 50 may operably engaged with the interior cylindrical wall 30D inside of the interior chamber 30E. In the illustrated embodiment, biaser 50 is a torsion spring that applies rotational force on the second spool 30 and the film filter 40 to keep the film filter 40 taut or held at a desired tension (see FIG. 3A). It should be appreciated that any suitable torsion spring and/or biaser may be used to apply rotational force on the second spool 30 and the film filter 40 to keep the film filter 40 taut or held at a desired tension. Alternatively, biaser may a different device that places or maintains the film filter 40 in tension. Further, biaser may be located at a different location but still engaged with one of the spools 20, 30 to place or maintain the film filter 40 in a state of tension.

Filter assembly 10 may also include a drive assembly 60 that operably engages with one of the first spool 20 and the second spool 30 for advancing the film filter 40 in at least one linear direction relative to the focal plane sensor 8. In one instance, drive assembly 60 may operably engage with the first spool 20 for advancing the film filter 40 in at least one linear direction relative to the focal plane sensor 8. In another instance, drive assembly 60 may operably engage with the first spool 20 and the second spool 30 for advancing the film filter 40 in at least one linear direction relative to the focal plane sensor 8. Optical system 1 may also include at least one monitor device or encoder to determine the position of the film filter 40 relative to the focal plane sensor 8 when the drive assembly 60 advances the film filter 40 in at least one linear direction relative to the focal plane sensor 8. Such components and devices of drive assembly 60 are described in greater detail below.

Drive assembly 60 may include a motor 62 that is configured to advance the film filter 40 in at least one linear direction relative to the focal plane sensor 8. As used herein, linear direction refers to the movement of the film filter 40 in at least one direction and in one example moves the film filter in a forward and reverse direction. Drive assembly 60 may also include a drive shaft 64 that operably engages with the motor 62 to transfer rotational force generated by the motor 62 to the filter assembly 10. In one example, drive shaft 64 may be operably engaged with the first spool 20 of filter assembly 10 for advancing the film filter 40 in at least one linear direction relative to the focal plane sensor 8 by transferring rotational force from the motor 62 to first spool 20 (see FIGS. 3A-3B and 5). Continuing with this example, the drive shaft 64 may operably engage with the interior cylindrical wall 20D of first spool 20 inside of passageway 20F for advancing the film filter 40 in at least one linear direction relative to the focal plane sensor 8 by transferring rotational force from the motor 62 to first spool 20 (see FIG. 3A).

Optical system 1 may also include at least one controller 70 that electrically connects with at least one drive assembly 60. As best illustrated in FIGS. 3B-6, optical system 1 may include a single controller 70 that electrically connects with motor 62 of drive assembly 60. During operation, controller 70 may be configured for controlling the power state of motor 62 between an ON state and an OFF state when a desired filter of the set of filters 42 or a desired shutter of the set of shutters 44 is optically aligned with focal plane sensor 8. In one example, controller 70 may be omitted and the motor 62 may be configured to control the power state between an ON state and an OFF state when motor 62 is a stepper-type motor, which is described in greater detail below.

Optical system 1 may also include an encoder 80 that operably engages with and monitors drive assembly 60. As best seen in FIG. 3B, encoder 80 may be operably engaged with the drive shaft 64 and may monitor the rotation of the drive shaft 64 when rotated by motor 62. During operation, encoder 80 may be configured to determine when a filter of the set of filters 42 or a shutter of the set of shutters 44 is optically aligned with focal plane sensor 8 based on measuring the rotational position of the drive shaft 64 when rotated by motor 62. Such information may be sent to at least one controller 70 of optical system 1 for controlling the power state of motor 62 between an ON state and an OFF state.

Having now described optical system 1 with filter assembly 10, a method of using filter assembly 10 is described in more detail below.

Prior to using the optical system 1 with filter assembly 10 in a military operation, a desired film filter (e.g., film filter 40) may be wound and loaded on the first spool 20 and the second spool 30 (see FIG. 3A). In other exemplary embodiments, any suitable film filter may be wound and loaded to the first spool 20 and the second spool 30 in which the film filter includes a desired number of filters and desired number of shutters provided in a desired configuration as described and illustrated herein. Once the desired film filter is loaded, the optical system 1 is prepared for use in at least one military operation. It should be appreciated that while film filter 40 is being discussed, any other variations and/or configurations of film filters may be used or operate in a substantially similar way as described herein.

Once the film filter 40 is engaged with and wound about first spool 20 and second spool 30, an operator of optical system 1 may then utilize the filter assembly 10 for at least one military operation. Here, operator may manually instruct the drive assembly 60 to advance the film filter 40 in at least one linear direction relative to the focal plane sensor 8 via the controller 70. Alternatively, controller 70 may automatically instruct the drive assembly 60 to advance the film filter 40 in at least one linear direction relative to the focal plane sensor 8 without operator intervention due to an on-board control system of a platform being electrically connected with optical system 1. Such examples of advancing the film filter 40 relative to the focal plane sensor 8 via the drive assembly 60 are described in more detail below.

Initially, motor 62 may generate a rotational force on drive shaft 64 in a first rotational direction to align a desired filter from the set of filters 42; such rotational force generated on drive shaft 64 by motor 62 is denoted by a double arrow labeled “R” as shown in FIG. 3B. At this state, controller 70 may command and/or instruct the motor 62 to generate a rotational force on drive shaft 64 in the first rotational direction until at least one desired filter of the set of filters 42 is optically aligned with focal plane sensor 8. As stated above, encoder 80 is configured to measure and/or monitor the rotational position of drive shaft 64 to determine when a specific filter of the set of filters 42 is optically aligned with focal plane sensor 8. Encoder 80 may then send a signal to controller 70 when the at least one desired filter of the set of filters 42 is optically aligned with focal plane sensor 8. At this point, controller 70 then commands motor 62 to cease rotational force applied on drive shaft 64 in the first rotational direction since the at least one desired filter of the set of filters 42 is optically aligned with focal plane sensor 8. Once aligned, the at least one desired filter of the set of filters 42 may then transmits a desired color or wavelength of light at the focal plane sensor 8.

If at least another desired filter of the set of filters 42 is to be used, the nearest shutter in the set of shutters 44 may be optically aligned with the focal plane sensor 8 for recalibrating focal plane sensor 8. Similar to the operations above, motor 62 may generate another rotational force on drive shaft 64 in a second rotational direction to align a desired shutter from the set of shutters 44; the second rotational direction may be the same as or different from the first rotational direction discussed above. At this state, controller 70 may command and/or instruct the motor 62 to generate a rotational force on drive shaft 64 in the second rotational direction until the desired shutter or the nearest shutter of the set of shutters 44 is optically aligned with focal plane sensor 8. As stated above, encoder 80 is also configured to measure and/or monitor the rotational position of drive shaft 64 to determine when the nearest shutter of the set of shutters 44 is optically aligned with focal plane sensor 8. Encoder 80 may then send a signal to controller 70 when the nearest shutter of the set of shutters 44 is optically aligned with focal plane sensor 8. At this point, controller 70 commands motor 62 to cease rotational force applied on drive shaft 64 in the second rotational direction since the nearest shutter of the set of shutters 44 is optically aligned with focal plane sensor 8. Once aligned, the nearest shutter of the set of shutters 44 may then prevent transmission of the light from entering into focal plane sensor 8 for recalibrating and/or resetting focal plane sensor 8 before another color or wavelength of light enters into focal plane sensor 8.

It should be appreciated that the steps of directly aligning at least one desired filter of the set of filters 42 with focal plane sensor 8 may be repeated any suitable number of times and/or cycles dictated by the number of colors or wavelengths that focal plane sensor 8 needs to analyze for a given military operation. It should also be appreciated that the steps of directly aligning at least one desired shutter or nearest shutter of the set of shutters 44 with focal plane sensor 8 may be repeated any suitable number of times and/or cycles dictated by the number of colors or wavelengths that focal plane sensor 8 needs to analyze for a given military operation.

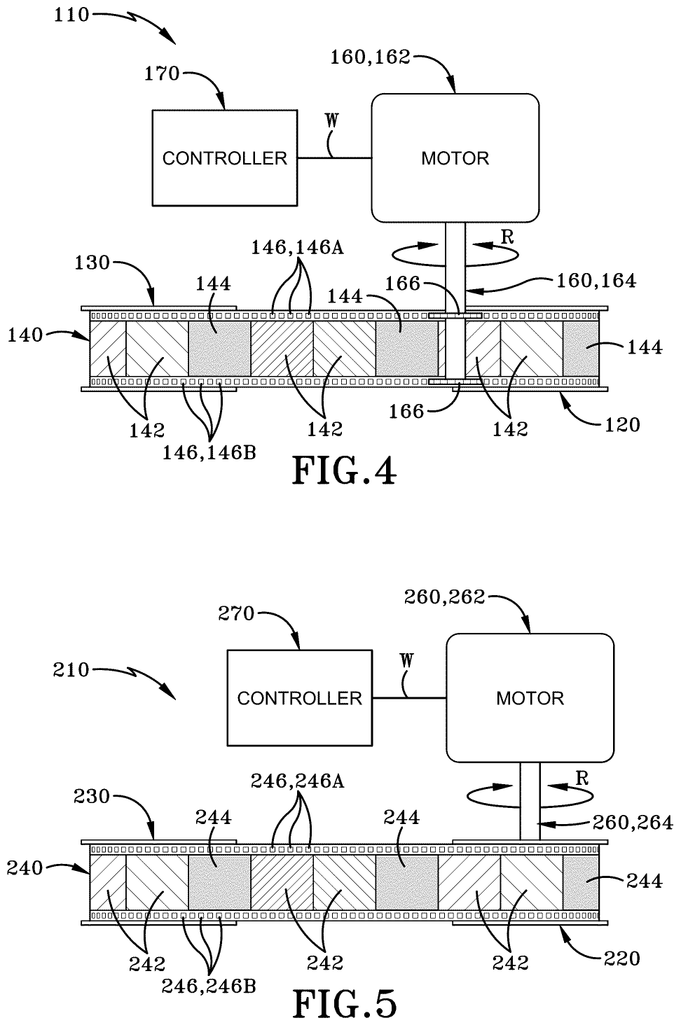

FIG. 4 illustrates another filter assembly 110 that is configured to be used with lens assembly 2 and focal plane sensor 8 of optical system 1. Filter assembly 110 is similar to filter assembly 10 described above and illustrated in FIGS. 1-3B, except as described in more detail below.

In this illustrated embodiment, filter assembly 110 may include a first spool 120, a second spool 130, a film filter 140, a drive assembly 160, and controller 170 that are substantially similar to first spool 20, second spool 30, film filter 40, drive assembly 60, and controller 70 of filter assembly 10. In regards to film filter 140, film filter 140 also includes a set of filters 142, a set of shutters 144, and a set of apertures 146A, 146B which are substantially similar to set of filters 42, set of shutters 44, and set of apertures 46A, 46B of film filter 40. In regards to drive assembly 160, drive assembly 160 also includes a motor 162 and a drive shaft 164 that are similar to motor 62 and drive shaft 64 of drive assembly 60.

In this illustrated embodiment, however, drive assembly 160 may also include a sprocket 166 that operably engages with the drive shaft 164. As best seen in FIG. 4, sprocket 166 may operably engage directly with film filter 140 inside the at least one set of apertures 146. More particularly, sprocket 166 may operably engage directly with film filter 140 inside the first set of apertures 146A and the second set of apertures 146B. Such engagement between the sprocket 166 and the film filter 140 enables the drive assembly 160 to advance the film filter 140 in at least one linear direction relative to the focal plane sensor 8. In other exemplary embodiments, any suitable device and/or component may be used with the drive shaft 164 to directly operably engage with the film filter 140 to advance the film filter 140 in at least one linear direction relative to the focal plane sensor 8.

In this illustrated embodiment, however, motor 162 may also be a stepper-type motor in which motor 162 measures and/or monitors the rotational direction and/or position of drive shaft 164 as motor 162 applies rotational force on drive shaft 164. As such, an encoder (such as encoder 80) may be omitted in this illustrated embodiment based on the motor 162 being a stepper-type motor. In other exemplary embodiments, motor 162 may be any suitable motor of a drive assembly described and illustrated herein for advancing film filter 140 in at least one linear direction for directly aligning at least one filter of the set of filters 142 or at least one shutter of the set of shutters 144 with focal plane sensor 8.

FIG. 5 illustrates another filter assembly 210 that is configured to be used with lens assembly 2 and focal plane sensor 8 of optical system 1. Filter assembly 210 is similar to filter assembly 10 described above and illustrated in FIGS. 1-3B, except as described in more detail below.

In this illustrated embodiment, filter assembly 210 may include a first spool 220, a second spool 230, a film filter 240, a drive assembly 260, and controller 270 that are substantially similar to first spool 20, second spool 30, film filter 40, drive assembly 60, and controller 70 of filter assembly 10. In regards to film filter 240, film filter 240 also includes a set of filters 242, a set of shutters 244, and a set of apertures 246A, 246B that are substantially similar to set of filters 42, set of shutters 44, and set of apertures 46A, 46B of film filter 40. In regards to drive assembly 260, drive assembly 260 also includes a motor 262 and a drive shaft 264 that are substantially similar to motor 62 and drive shaft 64 of drive assembly 60.

In this illustrated embodiment, however, motor 262 may also be a stepper-type motor in which motor 262 measures and/or monitors the rotational direction and/or position of drive shaft 264 as motor 262 applies rotational force on drive shaft 264. As such, an encoder (such as encoder 80) may be omitted in this illustrated embodiment based on the motor 262 being a stepper-type motor. In other exemplary embodiments, motor 262 may any suitable motor of a drive assembly described and illustrated herein for advancing film filter 240 in at least one linear direction for directly aligning at least one filter of the set of filters 242 or at least one shutter of the set of shutters 244 with focal plane sensor 8.

FIG. 6 illustrates another filter assembly 310 that is configured to be used with lens assembly 2 and focal plane sensor 8 of optical system 1. Filter assembly 310 is similar to filter assembly 10 described above and illustrated in FIGS. 1-3B, except as described in more detail below.

In this illustrated embodiment, filter assembly 310 may include a first spool 320, a second spool 330, a film filter 340, a drive assembly 360, and controller (not illustrated herein) that are substantially similar to first spool 20, second spool 30, film filter 40, drive assembly 60, and controller 70 of filter assembly 10. In regards to film filter 340, film filter 340 also includes a set of filters 342, a set of shutters 344, and a set of apertures 346A, 346B that are substantially similar to set of filters 42, set of shutters 44, and set of apertures 46A, 46B of film filter 40. In regards to drive assembly 360, drive assembly 360 also includes a motor 362 and a drive shaft 364 that are similar to motor 62 and drive shaft 64 of drive assembly 60.

In this illustrated embodiment, however, filter assembly 310 may include an optical encoder system 380 that operably engages with and monitors drive assembly 360. As best seen in FIG. 6, optical encoder system 380 includes a transceiver 380A that may be positioned above the film filter 340 and a receiver 380B that may be positioned below the film filter 340 and positioned directly below transceiver 380A. During operation, transceiver 380A may emit at least one light signal or beam 380C at the film filter 340 where the at least one light signal 380C may be received by the receiver 380B. If the at least one light signal 380C is received by the receiver 380B, the receiver 380B is configured to determine which filter of the set of filters 342 is optically aligned with the focal plane sensor 8 based on the color and/or wavelength received by receiver 380B. Such information may be sent to controller (not illustrated herein) for controlling the power state of motor 362 between an ON state and an OFF state when a desired filter of the set of filters 342 is optically aligned with the focal plane sensor 8. If the at least one light signal 380C fails to be received by the receiver 380B, the receiver 380B is configured to determine a shutter of the set of shutters 344 is optically aligned with the focal plane sensor 8 based on the lack color and/or wavelength received by receiver 380B. Such information may also be sent to controller for controlling the power state of motor 362 between an ON state and an OFF state when a desired shutter the set of shutters 344 is optically aligned with the focal plane sensor 8.

It should be appreciated that optical encoder 380 may be positioned at any suitable location and/or position along the film filter 340 for measuring and/or monitoring specific filters in the set of filters 342 and specific shutters in the set of shutters 344. In one exemplary embodiment, optical encoder 380 may be positioned between focal plane sensor 8 and first spool 320 (see FIG. 6). In another exemplary embodiment, optical encoder 380 may be positioned between focal plane sensor 8 and second spool 330. In yet another exemplary embodiment, the optical encoder may also be configured to directly monitor the position of at least one spool (e.g., first spool 320) or the drive shaft 364. In this particular exemplary embodiment, the optical encoder would then be operably engaged with and/or attached to the drive shaft 364 to directly monitor the position of at least one spool (e.g., first spool 320) or the drive shaft 364.

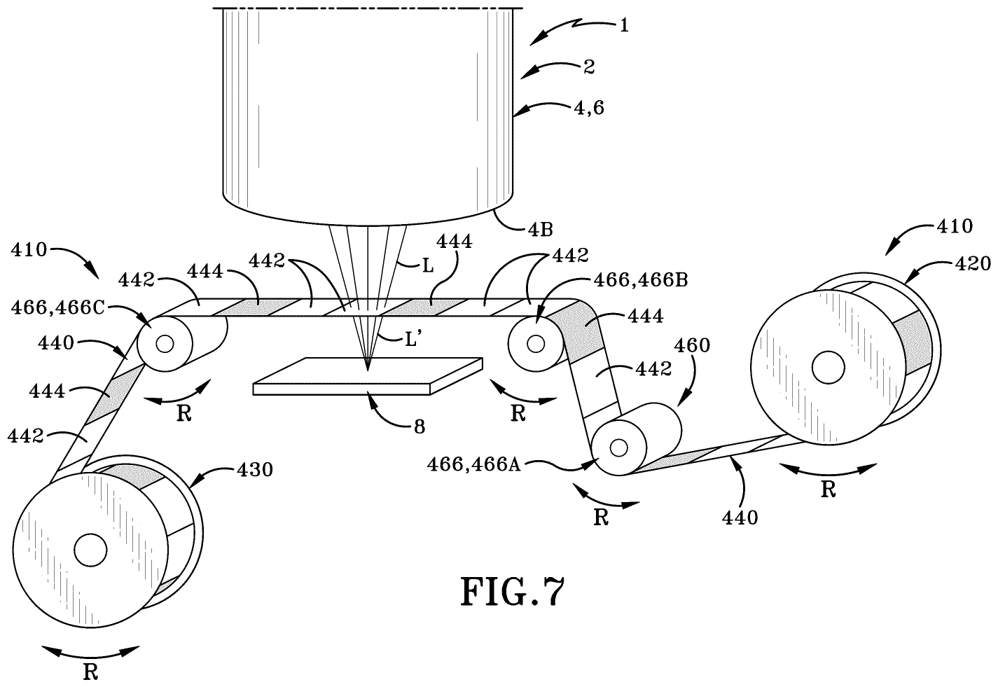

FIG. 7 illustrates another filter assembly 410 that is configured to be used with lens assembly 2 and focal plane sensor 8 of optical system 1. Filter assembly 410 is similar to filter assembly 10 described above and illustrated in FIGS. 1-3B, except as described in more detail below.

In this illustrated embodiment, filter assembly 410 may include a first spool 420, a second spool 430, a film filter 440, a drive assembly 460, and controller (not illustrated herein) that are similar to first spool 20, second spool 30, film filter 40, drive assembly 60, and controller 70 of filter assembly 10. In regards to film filter 440, film filter 440 also includes a set of filters 442, a set of shutters 444, and a set of apertures 446A, 446B that are substantially similar to set of filters 42, set of shutters 44, and set of apertures 46A, 46B of film filter 40.

In this illustrated embodiment, however, drive assembly 460 may also include roller assembly or relay assembly 466 that operably engages with the filter assembly 10. As best seen in FIG. 7, the roller assembly 466 is configured to operably engage with a portion of the film filter 440 to further guide and/or direct the film filter 440 relative to the focal plane sensor 8 when first spool 420 and second spool 430 are remote and/or spaced away from the lens assembly 2 and/or the focal plane sensor 8 compared to previously-described and illustrated positions of a first spool and a second spool relative to lens assembly 2 and/or focal plane sensor 8. Such configuration may be desirable or appreciated when the first spool 420 or the second spool 430 must be positioned remote from the lens assembly 2 or the focal plane sensor 8 due to various consideration, including the space allotted for the optical system 1 on a platform, the overall length of the film filter 440, and other various considerations constraining the position of one or both of the first spool 420 and the second spool 430.

In the illustrated embodiment, roller assembly 466 may include a first roller mechanism 466A positioned between focal plane sensor 8 and first spool 420 proximate to first spool 420. First roller mechanism 466A may also be positioned vertically below first spool 420 and focal plane sensor 8. Roller assembly 466 may include a second roller mechanism 466B positioned between focal plane sensor 8 and first roller mechanism 466A. Second roller mechanism 466B may also be positioned vertically above first roller mechanism 466A while being horizontally aligned with first spool 420 and focal plane sensor 8. Roller assembly 466 may include a third roller mechanism 466C positioned between the focal plane sensor 8 and second spool 430. Third roller mechanism 466C may also be positioned vertically above second spool 430 while be in line with focal plane sensor 8 and second roller mechanism 466B.

It should be appreciated that each of first roller mechanism 466A, second roller mechanism 466B, and third roller mechanism 466C may be positioned at any suitable location and/or elevation relative to one or both of first spool 420 and second spool 430 as well as focal plane sensor 8 while maintaining tension along film filter 440.

Still referring to FIG. 7, the roller assembly 466 may be operably engaged with a motor and a drive shaft described and illustrated herein (such as motor 62 and drive shaft 64) or other suitable driving devices and components for controlling the rotation of the at least one roller mechanism of roller assembly 466. In the illustrated embodiment, first roller mechanism 466A may be operably engaged with a motor and a drive shaft described and illustrated herein (such as motor 62 and drive shaft 64) or other suitable driving devices and components for controlling the rotation of the first roller mechanism 466A. Such rotation of the first roller mechanism 466A may enable the first roller mechanism 466A to advance the film filter 440 in at least one linear direction until a desired filter of the set of filters 442 is optically aligned with focal plane sensor 8 or until a desired shutter of the set of shutters 444 is optically aligned with focal plane sensor 8.

While a single roller mechanism 466A is configured to advance the film filter 440 in at least one linear direction, other suitable devices and/or mechanisms may be used to advance the film filter 440 in at least one linear direction. In one exemplary embodiment, second roller mechanism 466B and third roller mechanism 466C may also be operably engaged with a drive assembly described and illustrated herein (such as drive assembly 60) or other suitable drive assembly for controlling the rotation of second roller mechanism 466B and third roller mechanism 466C. Such rotation of these roller mechanisms 466B, 466C may enable one or both of second and third roller mechanisms 466B, 466C to advance the film filter 440 in at least one linear direction until a desired filter of the set of filters 442 is optically aligned with focal plane sensor 8 or until a desired shutter of the set of shutters 444 is optically aligned with focal plane sensor 8. In another exemplary embodiment, one or all of the first roller mechanism 466A, second roller mechanism 466B, and third roller mechanism 466C may also freely rotate in place to further guide and/or direct the film filter 440 towards and/or away from the second spool 430 while one of first spool 420 and second spool 430 advances the film filter 40 via drive assembly 460 (such as filter assembly 10 described above).

As used herein, light or incidental light “L”, “L” that interacts with camera system 1 having a filter assembly described and illustrated herein (e.g., filter assemblies 10, 110, 210, 310, 410) may refer to the broad range of electromagnetic radiation with wavelengths from about 100 nanometers up to about 40 micrometers or microns. It should be appreciated that the range of wavelengths of light or incidental light described herein may include, but not limited to, ultraviolet light, visible light, near infrared light, midwave infrared light, and longwave infrared light.

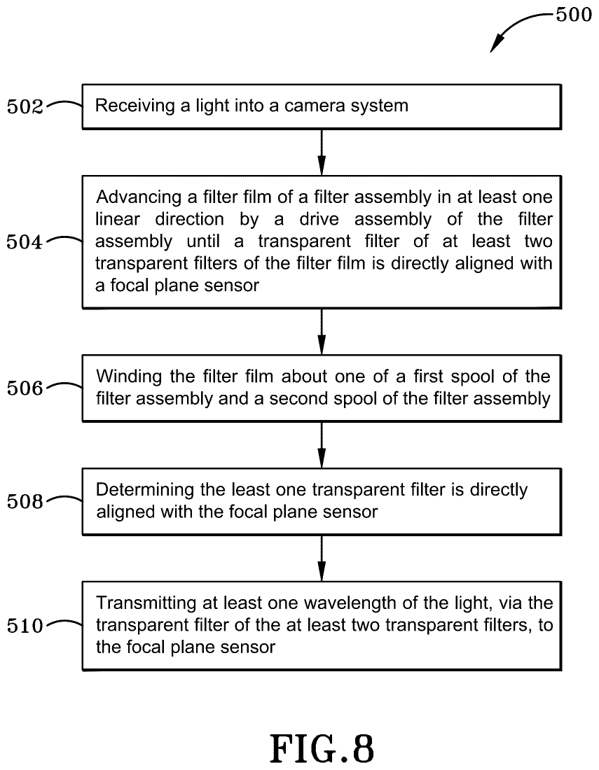

FIG. 8 illustrates a method 500. Initial step 502 of method 500 may include receiving a light into an optical system. Another step 504 of method 500 may also include advancing a film filter of a filter assembly in at least one linear direction by a drive assembly of the filter assembly until a filter of at least two filters of the film filter is optically aligned with a focal plane sensor. Another step 506 of method 500 may also include winding the film filter about one of a first spool of the filter assembly and a second spool of the filter assembly. Another step 508 of method 500 may also include determining the least one filter is optically aligned with the focal plane sensor. Another step 510 of method 500 may also include transmitting at least one wavelength of the light, via the filter of the at least two filters, to the focal plane sensor.

In other exemplary embodiments, method 500 may include additional steps or optional steps. Optional steps may further include advancing the film filter of the filter assembly in a second linear direction until at least another filter of the at least two filters of the film filter is optically aligned with the focal plane sensor; determining the least another filter is optically aligned with the focal plane sensor by an encoder of the filter assembly; and transmitting at least another wavelength of the light, via the at least one filter, to the focal plane sensor; wherein the at least another wavelength of the light is different than the at least one wavelength of the light. Optional steps may further include advancing the film filter of the filter assembly in a third linear direction until a non-uniform correction (NUC) shutter of the film filter is optically aligned with the focal plane sensor; and blocking the light, via the NUC shutter, from transmitting to the focal plane sensor. Optional steps may further include that the step of advancing the film filter of the filter assembly further comprises: engaging a drive shaft of a drive assembly of the filter assembly with one of the first spool and the second spool; and rotating the drive shaft, via a motor of the drive assembly, in the at least one linear direction. Optional steps may further include that the step of advancing the film filter of the filter assembly further comprises: engaging a sprocket of a drive assembly of the filter assembly with the film filter; and rotating a drive shaft of the drive assembly, via a motor of the drive assembly, in the at least one linear direction. Optional steps may further include that the step of advancing the film filter of the filter assembly further comprises: engaging at least one roller mechanism of a drive assembly with the film filter; and rotating the at least roller mechanism, via a motor of the drive assembly, in the at least one linear direction.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 466 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A filter assembly of an optical system, the filter assembly comprising:
a first spool;
a second spool;
a film filter operably engaged with the first spool and the second spool and the film filter having at least two filters that are different from one another; and
a drive assembly operably engaged with one of the first spool, the second spool, and the film filter for moving at least one filter of the at least two filters into optical alignment with a focal plane sensor of the optical system.

2. The filter assembly of claim 1, wherein the film filter is a flexible material that bends when wound about the first spool and the second spool.

3. The filter assembly of claim 1, wherein the film filter further comprises:
a first filter of the at least two filters defining a first filter modification for transmitting a first color of light to the focal plane sensor; and
a second filter of the at least two filters defining a second filter modification for transmitting a second color of light to the focal plane sensor;
wherein the first filter configuration and the second configuration are different from one another.

4. The filter assembly of claim 1, wherein the film filter further comprises:
at least one non-uniform correction (NUC) shutter positioned adjacent to one of the at least two filters;
wherein the at least one NUC shutter is nontransparent and substantially prevents light from being transmitted to the focal plane sensor.

5. The filter assembly of claim 1, further comprising:
at least one biaser operably engaged inside of one of the first spool and the second spool for providing tension along the film filter.

6. The filter assembly of claim 1, further comprising:
a motor of the drive assembly; and
a drive shaft operably engaged with the motor and one of the first spool and the second spool.

7. The filter assembly of claim 6, further comprising:
at least one encoder operably engaged with the drive shaft;
wherein the at least one encoder is adapted to monitor the drive shaft to determine when each filter of the at least two filters is aligned in front of the focal plane sensor.

8. The filter assembly of claim 7, wherein when the drive shaft rotates to a first rotational position, the at least one encoder determines that a first filter of the at least two filters is aligned in front of the focal plane sensor; and
wherein when the drive shaft rotates to a second rotational position different than the first rotational position, the at least one encoder determines that a second filter of the at least two filters is aligned with the focal plane sensor.

9. The filter assembly of claim 6, wherein the motor is a stepper-type motor adapted to monitor the rotation of the drive shaft to determine when each filter of the at least two filters is optically aligned with the focal plane sensor of the optical system.

10. The filter assembly of claim 9, wherein when the drive shaft rotates to a first rotational position, the motor determines that a first filter of the at least two filters is aligned with the focal plane sensor; and
wherein when the drive shaft rotates to a second rotational position different than the first rotational position, the motor determines that a second filter of the at least two filters is aligned with the focal plane sensor.

11. The filter assembly of claim 6, further comprising:
at least one optical encoder operably engaged with one of the film filter and the drive shaft of the drive assembly;
wherein the at least one optical encoder is adapted to monitor one of the film filter and the drive shaft to determine when each filter of the at least two filters is optically aligned with the focal plane sensor.

12. The filter assembly of claim 1, wherein the film filter further comprises:
a first end operably engaged with the first spool;
a second end opposite to the first end and operably engaged with the second spool; and
at least one set of apertures defined in the film filter and extending between the first end and the second end.

13. The filter assembly of claim 12, wherein the drive assembly comprises:
a motor of the drive assembly;
a drive shaft operably engaged with the motor; and
at least one sprocket operably engaged with the film filter via the at least one set of apertures.

14. The filter assembly of claim 1, further comprising:
at least one roller mechanism operably engaged with the film filter and positioned intermediately the first spool and the second spool;
wherein the drive assembly is operably engaged with the at least one roller mechanism for advancing the at least one filter of the at least two filters in front of the focal plane sensor of the optical system.

15. The filter assembly of claim 1, wherein the film filter is one of positioned between the focal plane sensor of the optical system and a lens assembly of the optical system, positioned ahead of the focal plane sensor and at a lens stop of the lens assembly, and positioned ahead of the focal plane sensor and the lens assembly.

16. A method, comprising:
receiving a light into an optical system;
advancing a film filter of a filter assembly in at least one linear direction by a drive assembly of the filter assembly until a filter of at least two filters of the film filter is optically aligned with a focal plane sensor;
winding the film filter about one of a first spool of the filter assembly and a second spool of the filter assembly;
determining the least one filter is optically aligned with the focal plane sensor; and
transmitting at least one wavelength of the light, via the filter of the at least two filters, to the focal plane sensor.

17. The method of claim 16, further comprising:
advancing the film filter of the filter assembly in a second linear direction until at least another filter of the at least two filters of the film filter is optically aligned with the focal plane sensor;
determining the least another filter is optically aligned with the focal plane sensor by an encoder of the filter assembly; and
transmitting at least another wavelength of the light, via the at least one filter, to the focal plane sensor;
wherein the at least another wavelength of the light is different than the at least one wavelength of the light.

18. The method of claim 16, further comprising:
advancing the film filter of the filter assembly in a third linear direction until a non-uniform correction (NUC) shutter of the film filter is optically aligned with the focal plane sensor; and
blocking the light, via the NUC shutter, from transmitting to the focal plane sensor.

19. The method of claim 16, wherein the step of advancing the film filter of the filter assembly further comprises:
engaging a drive shaft of a drive assembly of the filter assembly with one of the first spool and the second spool; and
rotating the drive shaft, via a motor of the drive assembly, in the at least one linear direction.

20. The method of claim 16, wherein the step of advancing the film filter of the filter assembly further comprises:
engaging a sprocket of a drive assembly of the filter assembly with the film filter; and
rotating a drive shaft of the drive assembly, via a motor of the drive assembly, in the at least one linear direction.

21. The method of claim 16, wherein the step of advancing the film filter of the filter assembly further comprises:
engaging at least one roller mechanism of a drive assembly with the film filter; and
rotating the at least roller mechanism, via a motor of the drive assembly, in the at least one linear direction.
